(19) United States
(12) Patent Application Publication
(10) Pub. No.: US 2006/0294084 A1
(43) Pub. Date: Dec. 28, 2006

(54) Methods and apparatus for a statistical system for targeting advertisements

(76) Inventors: Jayendu S. Patel, Somerville, MA (US); Dinesh Gopinath, Cambridge, MA (US)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, WESTBOROUGH, MA, 01581, US

(21) Appl. No.: 11/477,163

(22) Filed: Jun. 28, 2006

Related U.S. Application Data
(60) Provisional application No. 60/694,661, filed on Jun. 28, 2005.

(51) Int. Cl. G06F 17/30

(52) U.S. Cl. 707/3

(57) ABSTRACT

A system examines a user profile based on a knowledge associated with a user. The system examines a content context profile associated with a type of application and an application environment. The system examines an advertisement profile associated with a plurality of advertisements that include a plurality of attributes. The system then conditionally selects at least one preferred advertisement from the plurality of advertisements for presentation to the user. The at least one preferred advertisement is selected based on a statistical analysis of the user profile, the advertisement profile, and the content context profile.

### CLAIM TO BENEFIT OF EARLIER FILED PROVISIONAL APPLICATION

This Utility patent application claims the benefit of the filing date of the following earlier filed and co-pending U.S. Provisional Patent Application entitled “STATISTICAL SYSTEM FOR TARGETING ADS”, Attorney Docket Number CHS05-01p, filed Jun. 28, 2005 having U.S. Ser. No. 60/694,661. This utility Patent Application shares co-inventorship with the above-identified Provisional Patent Application and is assigned to the same assignee as this Provisional. The entire teachings and contents of the above-referenced Provisional Patent Application are hereby incorporated herein by reference in their entirety.

### BACKGROUND

Conventional technologies permit presentation advertisements to potential customers in a variety of media, including delivering those advertisements electronically, presenting advertisements on websites or via search engines. Advertisements can be displayed on websites, for example, via an advertisement banner. Advertisements can be displayed via a search engine via sponsored advertisements.

Conventional search engines produce web site listings in response to user provided queries (i.e., keyword or keyword phrases) entered into the search engine query form. The results (i.e., a listing of websites) are presented in order of highest to lowest relevance (with respect to the query) as determined by the search engines' algorithms. Users select (i.e., “click”) on the listing of their choice.

Search Engine Optimization techniques are used on web sites to achieve a high listing of those web sites in the search engine results. For example, a web site selling sailboats aspires to appear on the first page of search engine results whenever users enter a query of “sailboats” into a search engine query form. This is often referred to as “organic search engine listings”, or “natural search engine listings”.

For those advertisers who are willing to pay for a high listing (i.e., prominent listing) in the search engine results, sponsored advertisements are available. Sponsored advertisements are displayed along with “organic search engine listings”, but in regions on the display separate from the “organic search engine listings”. For example, depending on the search engine, sponsored advertisements may be displayed above the “organic search engine listings” or within a margin area on the display.

Advertisers create a sponsored advertisement following formatting guidelines provided by the search engines. The advertisement includes a hyperlink (i.e., a Universal Resource Locator, otherwise known as an “URL”) to the website. The website page associated with the hyperlink is referred to as the “landing page” since it is the page on which a user lands when a user selects (i.e., “clicks”) that sponsored ad.

Advertisers determine when their sponsored advertisements appear in response to user queries (i.e., keyword or keyword phrases). That is, the keywords or keyword phrases entered into a search engine by a user potentially trigger the advertisers' sponsored advertisements to appear. For example, a advertiser of a sailboat retail and repair store may want their sponsored advertisement to appear when users enter the keyword “sailboat” as a search engine query. Or, the advertiser of a sailboat retail and repair store may want their sponsored advertisement to appear when users enter the keyword phrase “sailboat repair” as a search engine query.

Advertisers pay for the sponsored advertisements by choosing keywords or keyword phrases, and competing against other advertisers who also want their sponsored advertisements to appear for user queries containing those same keyword or keyword phrases. Advertisers ‘bid’ against each other to affect the ranking of the appearance of their sponsored advertisements in response to user queries containing keyword or keyword phrases.

When a user enters a query containing keyword or keyword phrases, the sponsored advertisements (for which the advertisers have bid on keyword or keyword phrases) are displayed. The displaying of the sponsored advertisements is referred to as an ‘impression’. Typically, the advertisers do not pay for such ad impressions. However, when a user selects (i.e., “clicks”) on a sponsored ad, the advertiser is charged for that selection. The advertiser is charged whatever amount he bid on the keyword or keyword phrased that caused the displaying (i.e., impression) of the sponsored ad. Each time a user clicks on the sponsored ad, the advertiser is charged for that selection. This is known as “pay per click” model since the advertiser only pays for the sponsored advertisement when a user selects (i.e., “clicks”) on the sponsored advertisement.

### SUMMARY

Conventional technologies for targeting potential customers with sponsored advertisements suffer from a variety of deficiencies. In particular, conventional technologies for targeting potential customers with sponsored advertisements are limited in that little, if nothing, is known about the potential customer to whom the sponsored advertisement is presented. Additionally, when presenting sponsored advertisements via a search engine, the keyword or keyword phrase (KWs) entered by the potential customer determine which sponsored advertisements are displayed to the potential customer, with little regard as to whether those advertisements are the optimal advertisements for that particular potential customer. It should be noted that the term advertisement can include, but is not limited to, all types of advertising and related marketing content that lends itself to targeting, and which includes “normal advertisements”, “banner advertisements”, “sponsored links”, “promotions”, and “discount pricing”.

Embodiments disclosed herein significantly overcome such deficiencies and provide a system that includes a computer system executing an advertisement selecting process that selects a preferred advertisement for a user. The advertisement selecting process includes three components. At the core of the system is a user profiler that encapsulates the preferences of users in the advertising audience. The inputs to the user profiler include, but are not limited to, the most recent interests of the user. These can include recent searches, clicks, page views, purchases, previous advertisement clicks and impressions, and pertinent personalization profiles. The pertinent personalization profile can include the user's preferences and tastes in music, movies, television, games, searches (i.e., web searches such as, shopping, video, image, etc.), and retail. Registration data includes demographic information such as user age and gender, social economic information such as number of children in the household and household income, and geographic information such as current location or ZIP code, etc. The system automatically updates the advertisements selecting process incorporating advertising relevant preferences of users.

The content and context profiling component examines the context in which the advertisements and sponsored links (SLs) are presented. For example, the contexts in which the advertisements are presented include web pages, search results pages, mobile devices, call centers, etc. This component further examines the content of the page such as cars, computers and electronics, apparel, etc. Content and context profiling supports advertising targeting by restricting the advertisement selection pool to the relevant advertisements (for example, auto advertisements may be more relevant on a web page about cars and trucks, compared to a web page about health and medicine), and/or modulating user's preferences toward the “current” need of the user, such as recent researching a topic through search, shopping, etc. Consequently, promotional or information advertisements will be presented depending on the inferred user's stage in the buying process.

The advertisement profiling component refers to the examining, gathering and possible creation of attributes of the advertisements. Advertisements are associated with meta-data, typically by the advertiser or advertisement agency of the advertiser, to indicate the intended target audience segment. For example, 18-24 year olds living in particular location that searched or looked at “digital cameras” in the last 7 days may be specified a local camera retailer. In an Internet setting, advertisements may also be described through the attributes of the click-through web page. For example, the system may infer that an advertisement that takes the user to a men's apparel web page, is targeted towards males currently shopping for apparel.

It should be noted that application of embodiments disclosed herein is not restricted to the Internet advertising channel. It can be broadly applied to all advertising and marketing channels such as web, direct mail, catalogs, retail or street kiosks, in-bound and outbound call/customer service centers, mobile devices, TV, etc.

Embodiments disclosed herein include an advertisement selecting process that creates a user profile based on a knowledge associated with a user. The advertisement selecting process also creates a content context profile associated with the ad serving environment of the user. The advertisement selecting process then examines an advertisement profile associated with a plurality of advertisements (that includes a plurality of attributes). The advertisement selecting process then conditionally selects at least one preferred advertisement from the plurality of advertisements for presentation to the user. The preferred advertisement is selected based on a statistical analysis of the user profile, the advertisement profile, and the content context profile conditioned on business optimization metrics

During an example operation of one embodiment, suppose a user, enters the keyword phrase “Cape Cod” into a search engine. The advertisement selecting process has created a user profile on the user, based on knowledge associated with the user. The user profile can include websites the user has previously visited, prior web site searches, advertisements the user has selected, products and services purchased, etc. Based on the user profile, the user is assigned to one or more cohorts. The advertisement selecting process also creates a content context profile associated with the current environment where the user is and where the potential ads will be served, for example, the content context in which the user is searching for information related to “Cape Cod” and the user is navigating in a search engine. The advertisement selecting process examines an advertisement profile associated with a plurality of advertisements. Using the user profile, the content context profile and the advertisement profile, the advertisement selecting process chooses the preferred advertisement for the user. For example, if the user is assigned to a cohort of college students, the advertisement selecting process will select a ‘preferred’ advertisement related to budget lodging on Cape Cod and/or employment on Cape Cod.

Other embodiments disclosed herein include any type of computerized device, workstation, handheld or laptop computer, or the like configured with software and/or circuitry (e.g., a processor) to process any or all of the method operations disclosed herein. In other words, a computerized device such as a computer or a data communications device or any type of processor that is programmed or configured to operate as explained herein is considered an embodiment disclosed herein.

Other embodiments disclosed herein include software programs to perform the steps and operations summarized above and disclosed in detail below. One such embodiment comprises a computer program product that has a computer-readable medium including computer program logic encoded thereon that, when performed in a computerized device having a coupling of a memory and a processor, programs the processor to perform the operations disclosed herein. Such arrangements are typically provided as software, code and/or other data (e.g., data structures) arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained as embodiments disclosed herein.

It is to be understood that the system disclosed herein may be embodied strictly as a software program, as software and hardware, or as hardware alone. The embodiments disclosed herein, may be employed in data communications devices and other computerized devices and software systems for such devices such as those manufactured by ChoiceStream Inc. of Cambridge, Mass.

### BRIEF DESCRIPTION OF THE DRAWINGS

The foregoing will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 shows a high-level block diagram of the advertisement selecting process, including the user profile, the advertisement profile and the content context profile, according to one embodiment disclosed herein.

FIG. 2 shows a high-level block diagram of a computer system according to one embodiment disclosed herein.

FIG. 3 illustrates a flowchart of a procedure performed by the system of FIG. 1 when the advertisement selecting process examines a user profile based on a knowledge associated with a user, according to one embodiment disclosed herein.

FIG. 4 illustrates a flowchart of a procedure performed by the system of FIG. 1 when the advertisement selecting process creates a user profile based on a knowledge associated with a user, according to one embodiment disclosed herein.

FIG. 5 illustrates a flowchart of a procedure performed by the system of FIG. 1 when the advertisement selecting process creates a content context profile based on a knowledge associated with a user, according to one embodiment disclosed herein.

FIG. 6 illustrates a flowchart of a procedure performed by the system of FIG. 1 when the advertisement selecting process creates an advertisement profile based on a knowledge associated with a user, according to one embodiment disclosed herein.

FIG. 7 illustrates a flowchart of a procedure performed by the system of FIG. 1 when the advertisement selecting process examines a user profile and assigns the user to at least one cohort, according to one embodiment disclosed herein.

FIG. 8 illustrates a flowchart of a procedure performed by the system of FIG. 1 when the advertisement selecting process assigns the user to at least one cohort, according to one embodiment disclosed herein.

FIG. 9 illustrates a flowchart of a procedure performed by the system of FIG. 1 when the advertisement selecting process examines an advertisement profile associated with a plurality of advertisements, according to one embodiment disclosed herein.

FIG. 10 illustrates a flowchart of a procedure performed by the system of FIG. 1 when the advertisement selecting process examines a content context profile associated with a type of application and an application environment, according to one embodiment disclosed herein.

FIG. 11 illustrates a flowchart of a procedure performed by the system of FIG. 1 when the advertisement selecting process examines an advertisement profile associated with a plurality of advertisements, the plurality of advertisements including a plurality of attributes, according to one embodiment disclosed herein.

FIG. 12 illustrates a flowchart of a procedure performed by the system of FIG. 1 when the advertisement selecting process conditionally selects at least one preferred advertisement from the plurality of advertisements for presentation to the user, the at least one preferred advertisement selected based on a statistical analysis of the user profile, according to one embodiment disclosed herein.

FIG. 13 illustrates a flowchart of a procedure performed by the system of FIG. 1 when the advertisement selecting process calculates a probability that the user will select the at least one advertisement, according to one embodiment disclosed herein.

FIG. 14 illustrates a flowchart of a procedure performed by the system of FIG. 1 when the advertisement selecting process assesses a reaction of the user to the at least one advertisement, according to one embodiment disclosed herein.

FIG. 15 illustrates a flowchart of a procedure performed by the system of FIG. 1 when the advertisement selecting process utilizes the reaction of the user to perform at least one of a re-evaluation and a new update of the user profile, according to one embodiment disclosed herein.

FIG. 16 illustrates a flowchart of a procedure performed by the system of FIG. 1 when the advertisement selecting process, after the re-profile, updates the state of knowledge associated with the user profile, according to one embodiment disclosed herein.

FIG. 17 illustrates a flowchart of a procedure performed by the system of FIG. 1 when the advertisement selecting process receives at least one query from the user, according to one embodiment disclosed herein.

FIG. 18 illustrates a flowchart of a procedure performed by the system of FIG. 1 when the advertisement selecting process evaluates the search query, according to one embodiment disclosed herein.

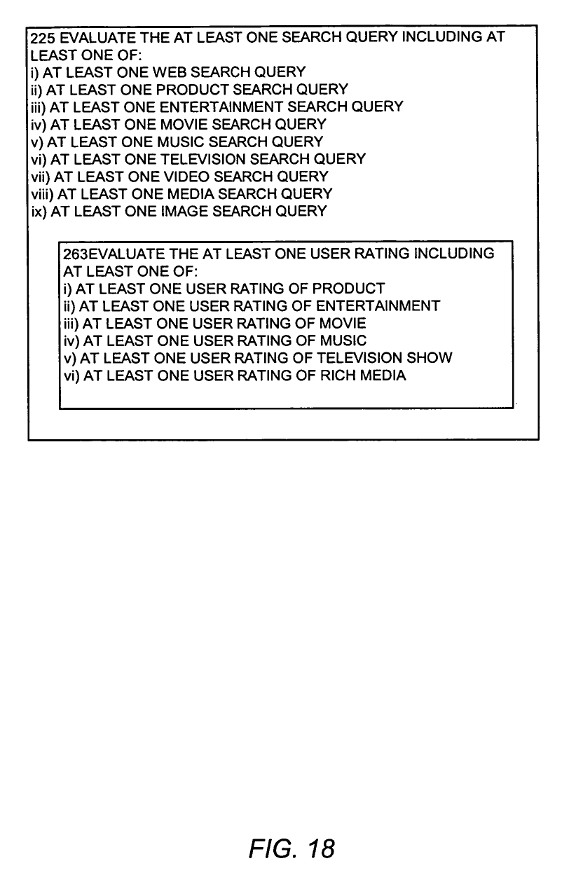

FIG. 19 illustrates a flowchart of a procedure performed by the system of FIG. 1 when the advertisement selecting process conditionally selects at least one preferred advertisement from the plurality of advertisements for presentation to the user, the at least one preferred advertisement selected based on a statistical analysis of the user profile, according to one embodiment disclosed herein.

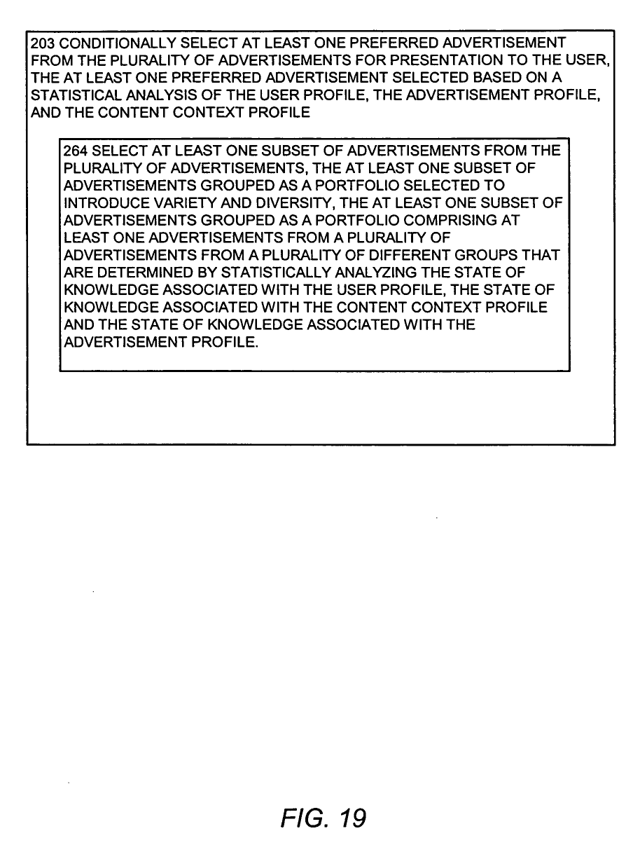

### DETAILED DESCRIPTION

Embodiments disclosed herein include a computer system executing an advertisement selecting process that selects an optimal advertisement for a user. It should be noted that the advertisement selecting process may execute on a plurality of computer systems. The advertisement selecting process includes three components. At the core of the system is a user profiler that encapsulates the preferences of users in the advertising audience. The inputs to the user profiler include, but are not limited to, the most recent interests of the user. These can include recent searches, clicks (i.e., user selected), page views, purchases, previous advertisement clicks and impressions, and pertinent personalization profiles. The pertinent personalization profile can include the user's preferences and tastes in music, movies, television, games, searches (i.e., web searches such as, shopping, video, image, etc.), and retail. Registration data includes demographic information such as user age and gender, social economic information such as number of children in the household and household income, and geographical information such as current location or ZIP code, etc. The system automatically updates the advertisements selecting process incorporating advertising relevant preferences of users.

The content and context profiling component examines the context in which the advertisements and sponsored links are presented. For example, the contexts in which the advertisements are presented include web pages, search results pages, mobile devices, call centers, etc. This component further examines the content of the page such as cars, computers and electronics, apparel, etc. Content and context profiling supports advertising targeting by restricting the advertisement selection pool to the relevant advertisements (for example, auto advertisements may be more relevant on a web page about cars and trucks, compared to a web page about health and medicine), and/or modulating user's preferences toward the “current” need of the user, such as recent researching a topic through search, shopping, etc. Consequently, promotional or information advertisements will be presented depending on the inferred user's stage in the buying process.

The advertisement profiling component refers to the examining, gathering and possible creation of attributes of the advertisements. Advertisements are associated with meta-data, typically by the advertiser or advertisement agency of the advertiser, to indicate the intended target audience segment. For example, 18-24 year olds living in particular location that searched or looked at “digital cameras” in the last 7 days may be specified a local camera retailer. In an Internet setting, advertisements may also be described through the attributes of the click-through web page. For example, the system may infer that an advertisement that takes the user to a men's apparel web page, is targeted towards males currently shopping for apparel.

It should be noted that application of embodiments disclosed herein is not restricted to the Internet advertising channel. It can be broadly applied to all advertising and marketing channels such as web, direct mail, catalogs, retail or street kiosks, in-bound and outbound call/customer service centers, mobile devices, TV, etc.

Embodiments disclosed herein include an advertisement selecting process that creates a user profile based on a knowledge associated with a user. The advertisement selecting process also creates a content context profile associated with the ad serving environment of the user. The advertisement selecting process then examines an advertisement profile associated with a plurality of advertisements (that includes a plurality of attributes). The advertisement selecting process then conditionally selects at least one preferred advertisement from the plurality of advertisements for presentation to the user. The preferred advertisement is selected based on a statistical analysis of the user profile, the advertisement profile, and the content context profile conditioned on business optimization metrics.

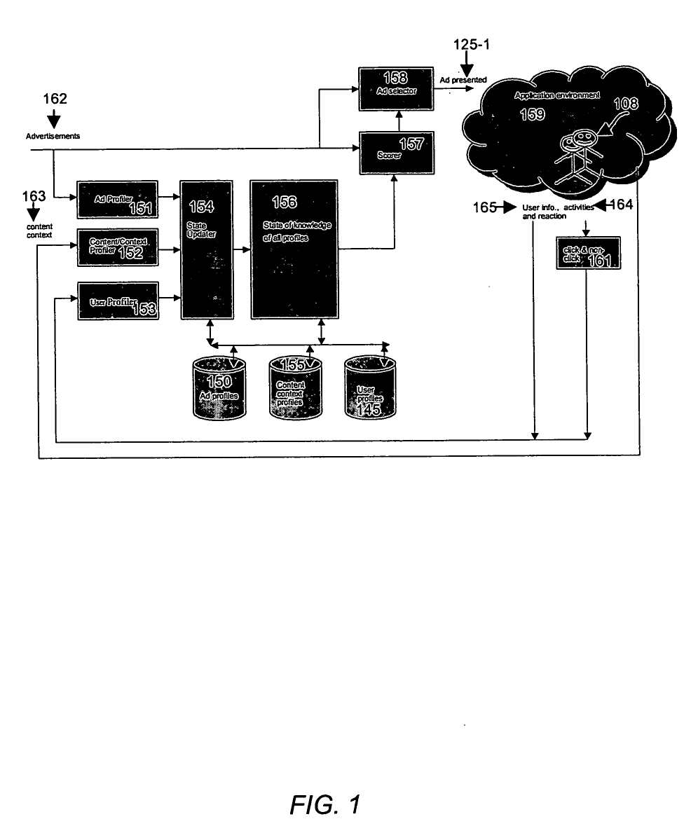

FIG. 1 is a high-level block diagram of the user profile 145, the advertisement profile 150 and the content context profile 155. The preferred advertisement 125-1 is selected by the advertisement selecting process 140-2, based on a statistical analysis of the user profile 145, the advertisement profile 150 and the content context profile 155. The advertisement selecting process 140-2 also re-profiles, and updates the user profile 145, the advertisement profile 150 and the content context profile 155 via a State Updater 154 that accepts input from the Ad Profiler 151, Content/Context Profiler 152, and User Profiler 153. The Content/Context Profiler 152 accepts content context input 163. The Scorer 157, Ad Selector 158 and Ad Profiler 151 accept Advertisements 162 as input. The preferred advertisement 125-1 is presented to the user 108 within an Application Environment 159. The user's activities 164 and user information and reaction 165, along with click and non click 161 information related to the preferred advertisement 125-1 is fed back into the User Profiler 153. It should be noted that any of these components may execute on the same computer system or on multiple computer systems.

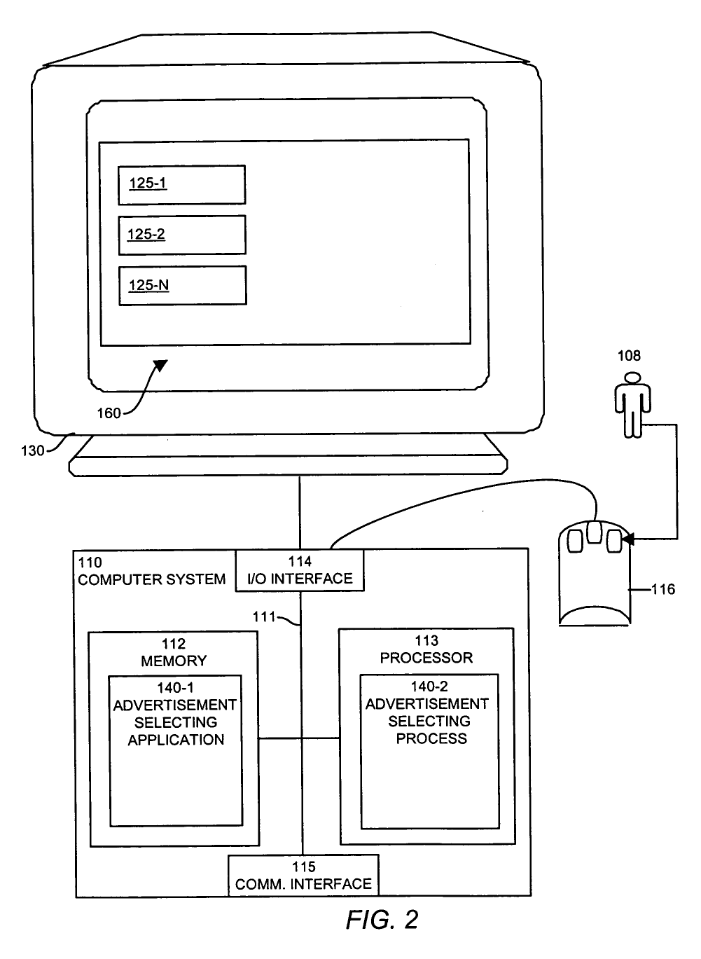

FIG. 2 is a block diagram illustrating example architecture of a computer system 110 that executes, runs, interprets, operates or otherwise performs an advertisement selecting application 140-1 and process 140-2. The computer system 110 may be any type of computerized device such as a personal computer, workstation, portable computing device, console, laptop, network terminal or the like. As shown in this example, the computer system 110 includes an interconnection mechanism 111 such as a data bus or other circuitry that couples a memory system 112, a processor 113, an input/output interface 114, and a communications interface 115. An input device 116 (e.g., one or more user/developer controlled devices such as a keyboard, mouse, etc.) couples to processor 113 through I/O interface 114, and enables a user 108 to provide input commands and generally control the graphical user interface 160 that the advertisement selecting application 140-1 and process 140-2 provides on the display 130. The graphical user interface 160 displays at least one preferred advertisement 125-1 to the user 108, the preferred advertisement 125-1 selected from a plurality of advertisements.

The memory system 112 is any type of computer readable medium and in this example is encoded with an advertisement selecting application 140-1. The advertisement selecting application 140-1 may be embodied as software code such as data and/or logic instructions (e.g., code stored in the memory or on another computer readable medium such as a removable disk) that supports processing functionality according to different embodiments described herein. During operation of the computer system 110, the processor 113 accesses the memory system 112 via the interconnect 111 in order to launch, run, execute, interpret or otherwise perform the logic instructions of the advertisement selecting application 140-1. Execution of advertisement selecting application 140-1 in this manner produces processing functionality in an advertisement selecting process 140-2. In other words, the advertisement selecting process 140-2 represents one or more portions of runtime instances of the advertisement selecting application 140-1 (or the entire application 140-1) performing or executing within or upon the processor 113 in the computerized device 110 at runtime.

Further details of configurations explained herein will now be provided with respect to a flow chart of processing steps that show the high level operations disclosed herein to perform the content formatting process.

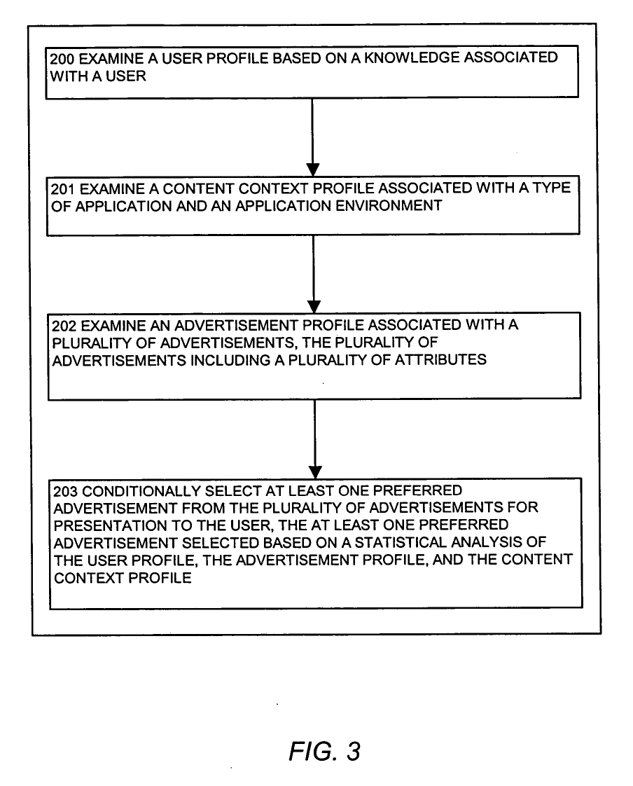

FIG. 3 is an embodiment of the steps performed by the advertisement selecting process 140-2 when it examines a user profile 145 based on a knowledge associated with a user 108.

In step 200, the advertisement selecting process 140-2 examines a user profile 145 based on a knowledge associated with a user 108. The user profile 145 encapsulates the preferences of the users 108 in the advertising audience. The inputs to the user profiler 145 can include, but are not limited to, recent interests such as recent searches, clicks, page views, purchases, previous advertisement clicks and impressions, and pertinent personalization profiles such as the user's 108 preferences and tastes in music, movies, TV, games, web searches (i.e., in general and particular verticals such as, shopping, video, image, etc.), and retail. Registration data in the user profile 145 can include demographic information such as age and gender, social economic information such as number of children in the household and household income, and geographic information such as current location or ZIP code, etc. The advertisement selecting process 140-2 automatically updates advertising relevant preferences of users 108.

In step 201, the advertisement selecting process 140-2 examines a content context profile 155 associated with a type of application and an application environment. The content context profile 155 captures the context in which the advertisements and sponsored links are surfaced. For example, the contexts in which the advertisements are surfaced include web pages, search results pages, mobile devices, call centers, etc. The process further captures the content of the page such as cars, computers and electronics, apparel, etc. Content and context profiling supports advertising targeting by restricting the advertisement selection pool to the relevant advertisements (for example, auto advertisements may be more relevant on a web page about cars and trucks compared to a web page about health and medicine) and/or modulating user's 108 preferences toward the “current” need of the user 108 such as examining user's recent researching a topic through search, shopping, etc. Consequently, promotional or information advertisements will be surfaced depending on the inferred user's stage in the buying process.

In step 202, the advertisement selecting process 140-2 examines an advertisement profile associated with a plurality of advertisements. The plurality of advertisements includes a plurality of attributes. The advertisements are associated with meta-data, typically by the advertiser or advertisement agency of the advertiser, to indicate the intended target audience segment. For example, 18-24 year olds living in particular locales that searched online for “digital cameras” in the last 7 days may be specified a local camera retailer. In an Internet setting, advertisements may also be described through the attributes of the click-through web page. For example, the advertisement selecting process 140-2 may infer that an advertisement which takes the user 108 to a men's apparel web page, is targeted towards males currently shopping for apparel.

In step 203, the advertisement selecting process 140-2 conditionally selects at least one preferred advertisement 125-1 from the plurality of advertisements for presentation to the user 108. The preferred advertisement 125-1 is selected based on a statistical analysis of the user profile 145, the advertisement profile 150, and the content context profile 155 and conditioned on business optimization metrics. In one embodiment, no advertisements are selected because the advertisement selecting process 140-2 did not deem any of the advertisements from the plurality of advertisements to meet the criteria of a preferred advertisement 125-1.

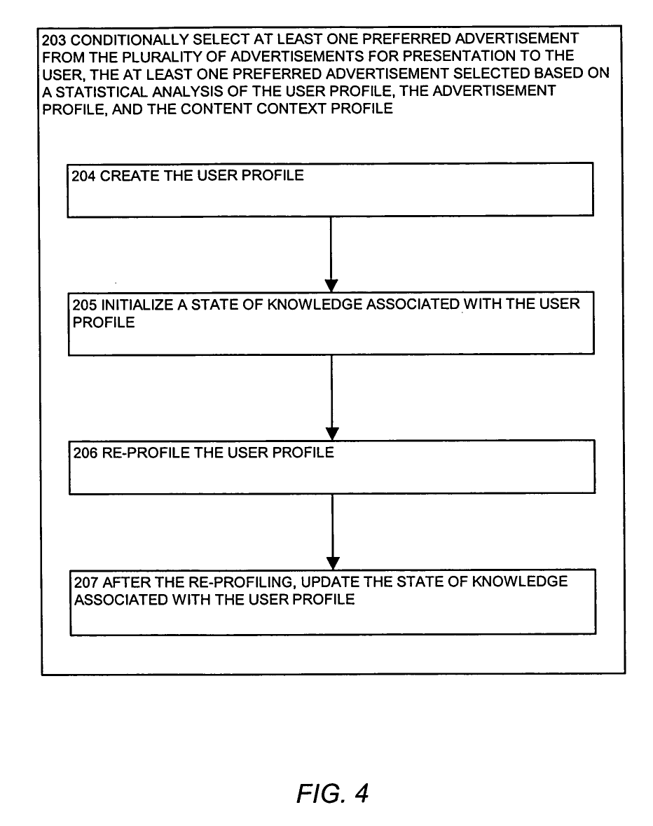

FIG. 4 is an embodiment of the steps performed by the advertisement selecting process 140-2 when it conditionally selects at least one preferred advertisement 125-1 from the plurality of advertisements for presentation to the user 108.

In step 204, the advertisement selecting process 140-2 creates the user profile 145. The user profile 145 is created based on information the advertisement selecting process 140-2 has compiled on the user 108. In the absence of this information, the advertisement selecting process 140-2 formulates assumptions about the user 108 and creates a default user profile 145, based on the assumptions.

In step 205, the advertisement selecting process 140-2 initializes a state of knowledge associated with the user profile 145. The state of knowledge is maintained by the advertisement selecting process 140-2 throughout the steps of examining the user profile 145, the advertisement profile 150, and the content context profile 155, and conditionally selecting the preferred advertisement 125-1.

In step 206, the advertisement selecting process 140-2 re-profiles the user profile 145. In an example embodiment, the advertisement selecting process 140-2 periodically re-profiles the user profile 145 to ensure a more accurate user profile 145 and to capture new information and activities from the user

In step 207, after the re-profiling, the advertisement selecting process 140-2 updates the state of knowledge associated with the user profile 145.

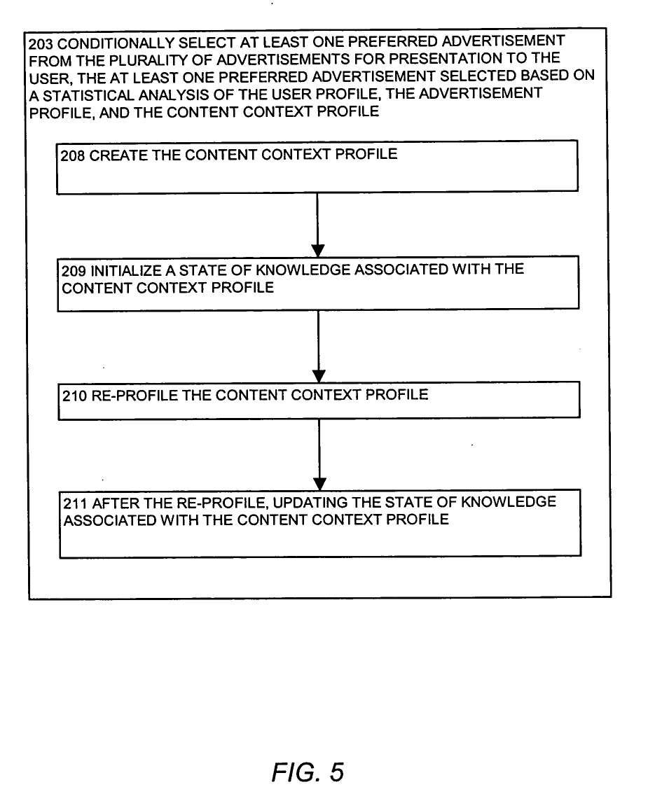

FIG. 5 is an embodiment of a continuation of the steps performed by the advertisement selecting process 140-2 when it conditionally selects at least one preferred advertisement 125-1 from the plurality of advertisements for presentation to the user 108.

In step 208, the advertisement selecting process 140-2 creates the content context profile 155.

In step 209, the advertisement selecting process 140-2 initializes a state of knowledge associated with the content context profile 155. The state of knowledge associated with the content context profile 155 is maintained by the advertisement selecting process 140-2 throughout the steps of examining the user profile 145, the advertisement profile 150, and the content context profile 155, and conditionally selecting the preferred advertisement 125-1.

In step 21 0, the advertisement selecting process 140-2 re-profiles the content context profile 155.

In step 211, after the re-profiling, the advertisement selecting process 140-2 updates the state of knowledge associated with the content context profile 155.

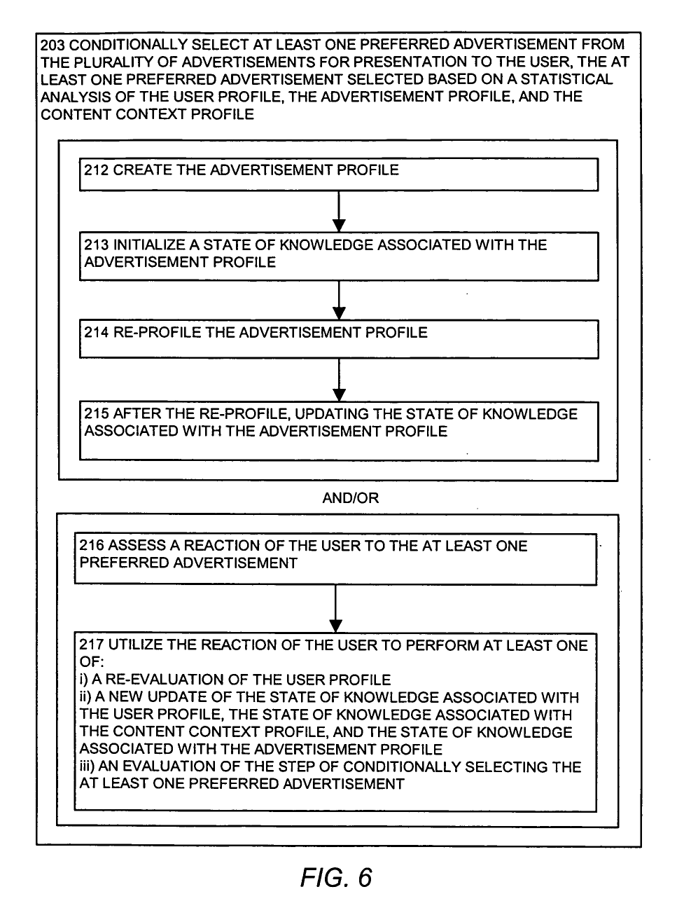

FIG. 6 is an embodiment of a continuation of the steps performed by the advertisement selecting process 140-2 when it conditionally selects at least one preferred advertisement 125-1 from the plurality of advertisements for presentation to the user 108.

In step 212, the advertisement selecting process 140-2 creates the advertisement profile 150.

In step 213, the advertisement selecting process 140-2 initializes a state of knowledge associated with the advertisement profile 150. The state of knowledge associated with the advertisement profile 150 is maintained by the advertisement selecting process 140-2 throughout the steps of examining the user profile 145, the advertisement profile 150, and the content context profile 155, and conditionally selecting the preferred advertisement 125-1.

In step 214, the advertisement selecting process 140-2 re-profiles the advertisement profile 150.

In step 215, after the re-profiling, the advertisement selecting process 140-2 updates the state of knowledge associated with the advertisement profile 150.

Alternatively, in step 216, the advertisement selecting process 140-2 assesses a reaction of the user 108 to the preferred advertisement 125-1. The advertisement selecting process 140-2 selects a preferred advertisement 125-1 for displaying to the user 108, based on a statistical analysis of the user profile 145, the advertisement profile 150, and the content context profile 155, and assesses the reaction of the user 108 to the preferred advertisement 125-1. For example, advertisement selecting process 140-2 may display the preferred advertisement 125-1 on a website on which the user 108 is browsing. The user 108 may click on the preferred advertisement 125-1, or may ignore it.

In step 217, the advertisement selecting process 140-2 utilizes the reaction of the user 108 (to the displaying of the preferred advertisement 125-1) to perform at least one of:

i) A re-evaluation of the user profile 145.

ii) A new update of the state of knowledge associated with the user profile 145, the state of knowledge associated with the content context profile 155, and the state of knowledge associated with the advertisement profile 150.

iii) An evaluation of the step of conditionally selecting the preferred advertisement 125-1.

User Profile and its Initialization to Default Cohort

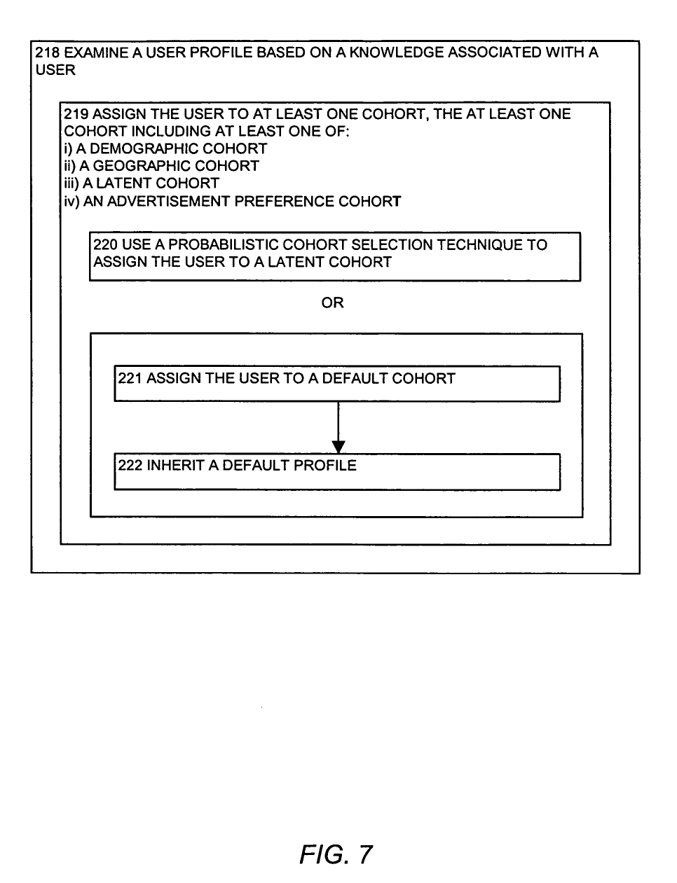

FIG. 7 is an embodiment of the steps performed by the advertisement selecting process 140-2 when it examines a user profile 145 based on a knowledge associated with a user 108.

In step 218, the advertisement selecting process 140-2 examines a user profile 145 based on a knowledge associated with a user 108. For example, the knowledge associated with a user 108 can be based on Internet activity of the user.

In step 219, the advertisement selecting process 140-2 assigns the user 108 to at least one cohort, the cohort including at least one of:

i) a demographic cohort,

ii) a geographic cohort,

iii) a latent cohort, and

iv) an advertisement preference cohort.

In step 220, the advertisement selecting process 140-2 uses a probabilistic cohort selection technique to assign the user 108 to a latent cohort. In an example embodiment, the advertisement selecting process 140-2 assigns the user 108 to multiple cohorts that are appropriate for that user 108.

In an example embodiment, the following formula is used:

Notation:

Pr(.)=probability of event in parentheses
SL=sponsored link (stand-in for any type of advertisement, promotions, coupons, etc.)
KW=key word used to fetch sponsored links from Sponsored-Link Server as necessary
SQ=vector of search queries made recently by user
U=vector of user's profile beside information on user's search queries
c(U)=user's cohort based on U, possibly latent
A=vector of relevant-to-user attributes of SL
X=vector of content context attributes, where content context is one in which links/ads are being served, etc.
Rev( )=revenue to portal or site from click (or other success outcome)

Note that X (content context) includes attention to information on application where the advertisements/links are to be displayed (such as on a travel site versus a finance site versus a health site) as well as information on date-of-display (such as weekday, holidays or weekend) and time-of-display (such as workday hours or evening), i.e., all measurable factors besides general attributes of the user that predict variations in propensity to click. For example, the user's 108 interests and click behavior in the run-up to Valentine's Day is likely to be different from that around Super Bowl. And late-night usage entails different moods than usage during the workday.

The relevant attributes, A, of any SL can be imputed by an attributizer that analyzes the associated web page/web site URL or by explicit information provided by the creator of the link/ad. The attributizer can be an automated system or use human scorers or a combination.

Relevant information of the user is the U-vector. In practice, measurement errors are addressed for Uby introducing latent cohorts and Bayesian exchangeability.

The typical set-up of the targeting system seeks to maximize expected revenue by choice of a portfolio of SLs. Consider the simpler case where we desire to find the best single SL for a user:

$${SL}^{*} = {arg max}_{SL} {Pr ( click \text{\vert} A , U , X )}^{′} Rev ( SL ) \qquad ( 1 )$$

The click probability is modeled as a logit model (or a probit model):

$$Pr ( click \text{\vert} U , A , X ) = \frac{exp ( {I}_{A , X \text{\vert} U} )}{1 + exp ( {I}_{A , X \text{\vert} U} )} \qquad ( 2 )$$

where the index I_{A,X|U}=Ab_{1U}+Xb_{2U}+AXb_{3U} has cohort-specific coefficients and allows for needed interactions between A and X.

One of the Suggested Click Model Embodiment—Latent Cohort Click Model:

Class/Cohort membership model: Given a user's 108 history, the class membership model predicts the probability of the user 108 being in a particular latent cohort c relevant to the advertising context. There are many types of class membership models we consider such as the multinomial logit class membership model:

$$Pr ( c \text{\vert} U ) = \frac{exp ( {V}_{c} ( U ) )}{{\sum }_{{c}^{′}}^{} exp ( {V}_{{c}^{′}} ( U ) )}$$

where V_{c}(U)=f (U;θ_{c}), θ_{c} is a parameter vector to be estimated, and K indicates the number of latent cohorts (—typically three to five latent cohorts proved adequate in our initial applications for targeted sponsored links).

Click-model given latent cohort: Given the latent cohort, the click-model predicts the probability of clicking a particular advertisement and is written as:

$$Pr ( click \text{\vert} c , A , X ) = \frac{exp ( {I}_{A , X \text{\vert} c} )}{1 + exp ( {I}_{A , X \text{\vert} c} )}$$

where I_{A,X|C}=g(A,X;b_{c}). For example, I_{A,X|c} maybe specified as linear-in-parameters index function, i.e., I_{A,X|c}=Ab_{1c}+Xb_{2c}+AXb_{3c}. Note that the coefficients of the conditional click model vary across the cohorts.

Combining the two sub-models, the click model is written as:

$$Pr ( click \text{\vert} U , A , X ) = {å}_{c = 1}^{K} \frac{exp ( {I}_{A , X \text{\vert} c} )}{1 + exp ( {I}_{A , X \text{\vert} c} )} \frac{exp ( {V}_{c} ( U ) )}{{å}_{} exp ( {V}_{c¢} ( U ) )}$$

The coefficients of the latent-cohort click-choice model are estimated by maximum likelihood or by Bayesian methods, where the latter proving more robust. The latent-cohort conditional logit model for the targeting of sponsorlink advertisements (SL) is estimated from data of observed user-clicks (and non-clicks) on the SLs that are served up. The click data are from similar contexts to the use of the application (or adjusted otherwise). In practice, the click rate on SLs can be low (often below 1%); in such cases, we find that using all data with the rare click-events, say N observations, can be combined with a random sample of ION of non-click observations to obtain efficient unbiased estimates of the desired slope coefficients.

Updating the model coefficients towards the user 108, i.e., personalization of model coefficients is accomplished through a Bayesian model updating scheme.

Alternatively, in step 221, the advertisement selecting process 140-2 assigns the user 108 to a default cohort. In one embodiment, the advertisement selecting process 140-2 has limited knowledge associated with the user 108, and therefore, cannot assign the user 108 to an appropriate cohort. The advertisement selecting process 140-2 assigns the user 108 to a default cohort. As the advertisement selecting process 140-2 obtains more knowledge associated with the user 108, the advertisement selecting process 140-2 is better able to assign the user 108 to the appropriate cohort or cohorts.

In step 222, the advertisement selecting process 140-2 inherits a default profile for the user 108. In an example embodiment, the advertisement selecting process 140-2 assigns the user 108 to a default cohort, and inherits a default profile for that user 108.

Knowledge of User and Activities of User

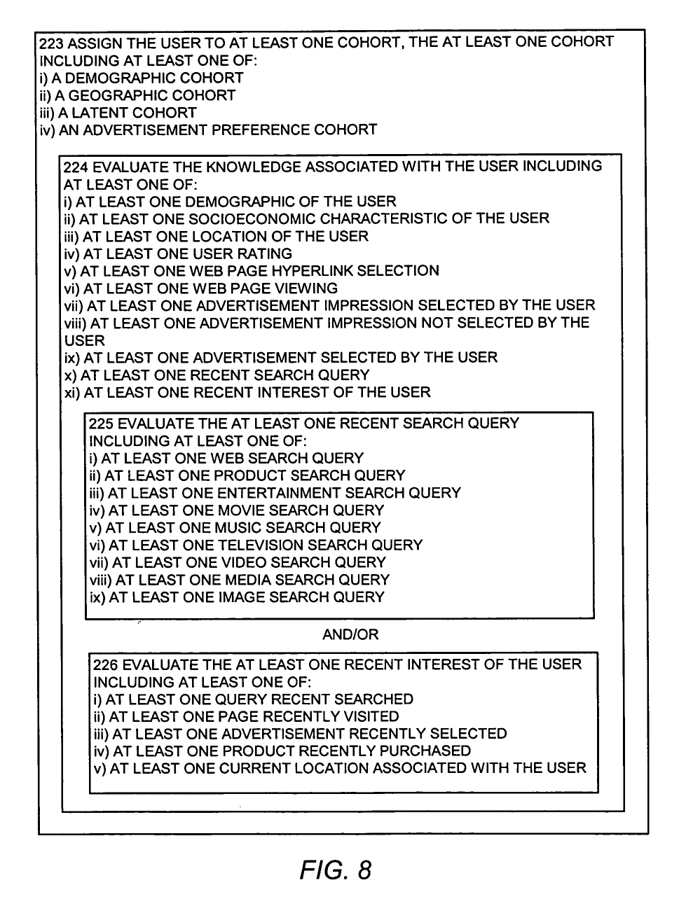

FIG. 8 is an embodiment of the steps performed by the advertisement selecting process 140-2 when it assigns the user 108 to at least one cohort.

In step 223, the advertisement selecting process 140-2 assigns the user 108 to at least one cohort, the cohort including at least one of:

i) a demographic cohort,

ii) a geographic cohort,

iii) a latent cohort, and

iv) an advertisement preference cohort.

In step 224, the advertisement selecting process 140-2 evaluates the knowledge associated with the user 108 including at least one of:

i) at least one demographic of the user 108,

ii) at least one socioeconomic characteristic of the user 108,

iii) at least one location of the user 108,

iv) at least one user rating,

v) at least one web page hyperlink selection,

vi) at least one web page viewing,

vii) at least one advertisement impression selected by the user 108,

viii) at least one advertisement impression not selected by the user 108,

ix) at least one recent search query, and

x) at least one recent interest of the user.

In step 263, the advertisement selecting process 140-2 evaluates the user rating including at least one of:

i) at least one user rating of product,

ii) at least one user rating of entertainment,

iii) at least one user rating of movie,

iv) at least one user rating of music,

v) at least one user rating of television show, and

vi) at least one user rating of rich media.

In step 225, the advertisement selecting process 140-2 evaluates the search query including at least one of:

i) at least one web search query,

ii) at least one product search query,

iii) at least one entertainment search query,

iv) at least one movie search query,

v) at least one music search query,

vi) at least one television search query,

vii) at least one video search query,

viii) at least one media search query, and

ix) at least one image search query.

Alternatively, in step 226, the advertisement selecting process 140-2 evaluates a recent interest of the user 108 including at least one of:

i) at least one recent searched query,

ii) at least one page recently visited,

iii) at least one advertisement recently selected,

iv) at least one product recently purchased,

v) at least one product recently shopped for, and

vi) at least one current location associated with the user 108.

Types of Advertisements

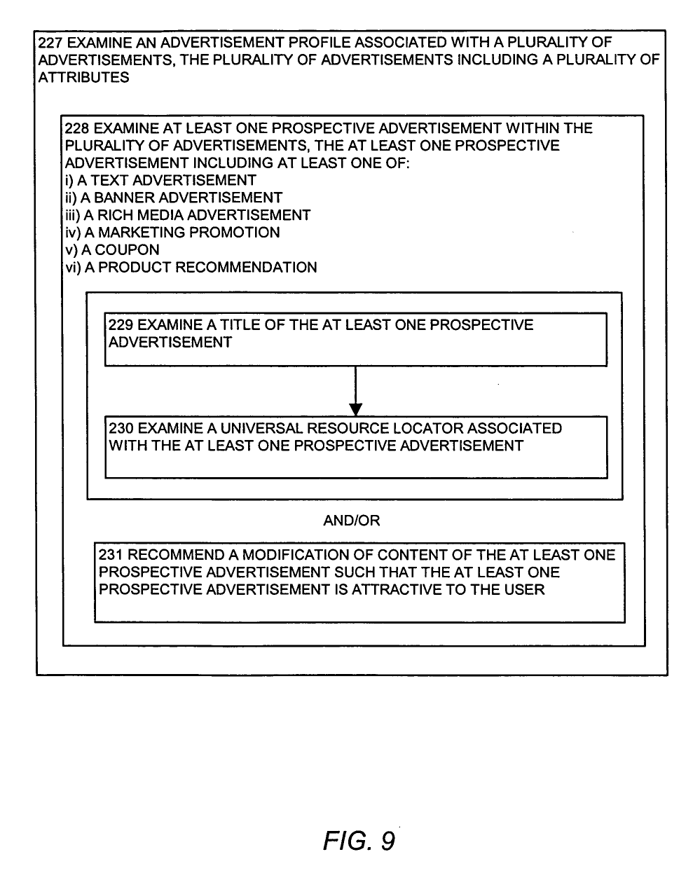

FIG. 9 is an embodiment of the steps performed by the advertisement selecting process 140-2 when it examines an advertisement profile associated with a plurality of advertisements.

In step 227, the advertisement selecting process 140-2 examines an advertisement profile associated with a plurality of advertisements. The plurality of advertisements includes a plurality of attributes.

In step 228, the advertisement selecting process 140-2 examines at least one prospective advertisement within the plurality of advertisements. The prospective advertisement including at least one of:

i) a text advertisement,

ii) a banner advertisement,

iii) a rich media advertisement,

iv) a marketing promotion,

v) a coupon, and

vi) a product recommendation.

In step 229, the advertisement selecting process 140-2 examines a title of the prospective advertisement. For example, a sponsored advertisement can contain a title of the advertisement. Often, the title is hyper linked to a web page on which the advertisement directs a user 108.

In step 230, the advertisement selecting process 140-2 examines a universal resource locator (URL) associated with the prospective advertisement. For example, a sponsored advertisement contains a hyper link directing a user 108 to a website location specified by the advertisement.

In step 231, the advertisement selecting process 140-2 may produce suggestions and recommendations back to the advertisers in suggesting a modification of content of the prospective advertisement such that the prospective advertisement is attractive to the user 108. In an example embodiment, the advertisement selecting process 140-2 inspects, for example, a sponsored advertisement. The advertisement selecting process 140-2 examines the title of the sponsored advertisement, the content of the sponsored advertisement, as well as the landing page to which a hyper link within the sponsored advertisement directs the user 108. The advertisement selecting process 140-2 may produce suggestions and recommendations back to the advertisers in suggesting modifications to the sponsored advertisement such that the sponsored advertisement achieves a greater result (for example, attracting a user 108 to make a purchase, etc.).

Types and Attributes of Content Context Profile

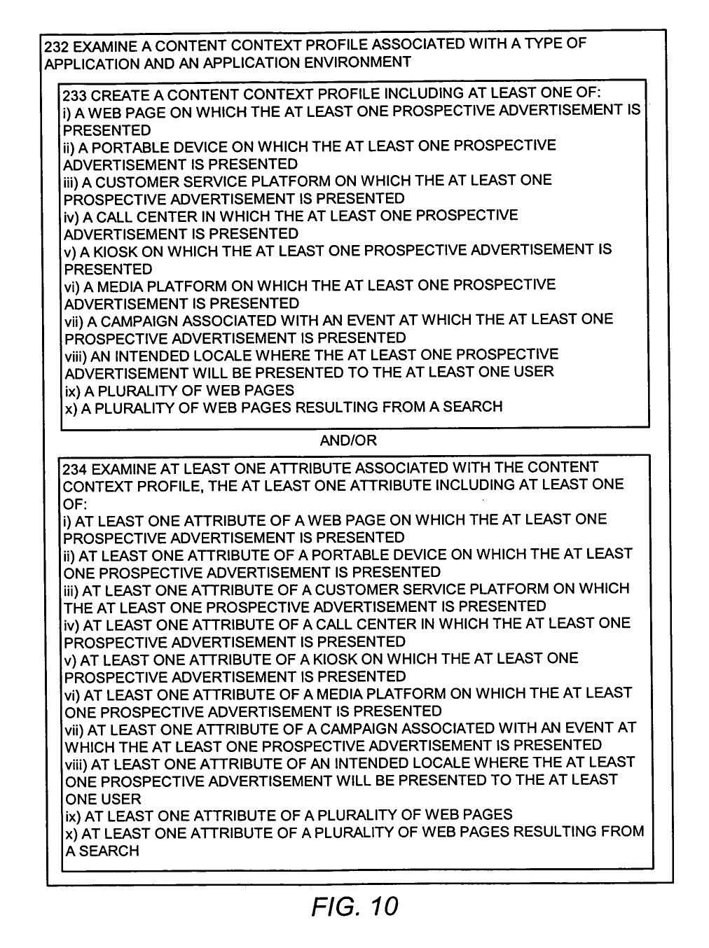

FIG. 10 is an embodiment of the steps performed by the advertisement selecting process 140-2 when it examines a content context profile 155 associated with a type of application and an application environment.

In step 232, the advertisement selecting process 140-2 examines a content context profile 155 associated with a type of application and an application environment. For example, context can include the time-of-day, day-of-week, purpose of area where sponsored advertisements are being served, etc.

In step 233, the advertisement selecting process 140-2 creates a content context profile including at least one of:

i) a web page on which the prospective advertisement is presented,

ii) a portable device on which the prospective advertisement is presented

iii) a customer service platform on which the prospective advertisement is presented,

iv) a call center in which the prospective advertisement is presented,

v) a kiosk on which the prospective advertisement is presented,

vi) a media platform on which the prospective advertisement is presented,

vii) a campaign associated with an event at which the prospective advertisement is presented,

viii) an intended locale where the prospective advertisement will be presented to the user 108,

ix) a plurality of web pages, and

x) a plurality of web pages resulting from a search.

In step 234, the advertisement selecting process 140-2 examines at least one attribute associated with the content context profile 155. The attribute including at least one of:

i) at least one attribute of a web page on which the prospective advertisement is presented,

ii) at least one attribute of a portable device on which the prospective advertisement is presented,

iii) at least one attribute of a customer service platform on which the prospective advertisement is presented,

iv) at least one attribute of a call center in which the prospective advertisement is presented,

v) at least one attribute of a kiosk on which the prospective advertisement is presented,

vi) at least one attribute of a media platform on which the prospective advertisement is presented,

vii) at least one attribute of a campaign associated with an event at which the prospective advertisement is presented,

viii) at least one attribute of an intended locale where the prospective advertisement will be presented to the user 108,

ix) at least one attribute of a plurality of web pages, and

x) at least one attribute of a plurality of web pages resulting from a search.

Ad Profiling and Examination of Ad Attributes

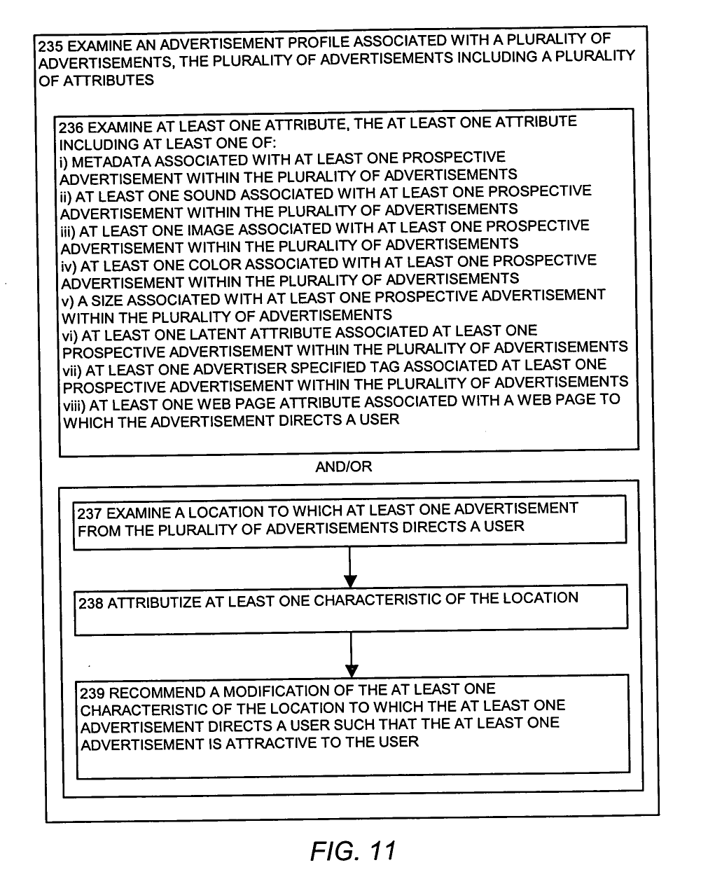

FIG. 11 is an embodiment of the steps performed by the advertisement selecting process 140-2 when it examines an advertisement profile 150 associated with a plurality of advertisements.

In step 235, the advertisement selecting process 140-2 examines an advertisement profile 150 associated with a plurality of advertisements. The plurality of advertisements includes a plurality of attributes such as the title of the advertisement, etc.

In step 236, the advertisement selecting process 140-2 examines at least one attribute, the attribute including at least one of:

i) metadata associated with at least one prospective advertisement within the plurality of advertisements,

ii) at least one sound associated with at least one prospective advertisement within the plurality of advertisements,

iii) at least one image associated with at least one prospective advertisement within the plurality of advertisements,

iv) at least one color associated with at least one prospective advertisement within the plurality of advertisements,

v) a size associated with at least one prospective advertisement within the plurality of advertisements,

vi) at least one latent attribute associated at least one prospective advertisement within the plurality of advertisements,

vii) at least one advertiser specified tag associated at least one prospective advertisement within the plurality of advertisements, and

viii) at least one web page attribute associated with a web page to which the advertisement directs a user 108.

Alternatively, in step 237, the advertisement selecting process 140-2 examines a location to which at least one advertisement from the plurality of advertisements directs a user 108. For example, a sponsored advertisement may contain a hyper link directing a user 108 to a web page containing more information associated with the advertisement.

In step 238, the advertisement selecting process 140-2 attributizes at least one characteristic of the location. In an example embodiment, the advertisement is a sponsored advertisement, pointing to a web page. The advertisement selecting process 140-2 examines the web page and identifies attributes of that web page.

In step 239, the advertisement selecting process 140-2 may produce suggestions and recommendations in suggesting a modification of the characteristic of the location to which the advertisement directs a user 108 such that the advertisement is attractive to the user 108. For example, after the advertisement selecting process 140-2 identifies attributes of the web page, the advertisement selecting process 140-2 recommends modifications to that web page to increase sales of the sponsored advertisement. In an example embodiment, the advertisement selecting process 140-2 recommends a modification of at least one characteristic of the location to which the advertisement directs a user 108 such that the advertisement is attractive to the user 108.

On Optimization Metrics

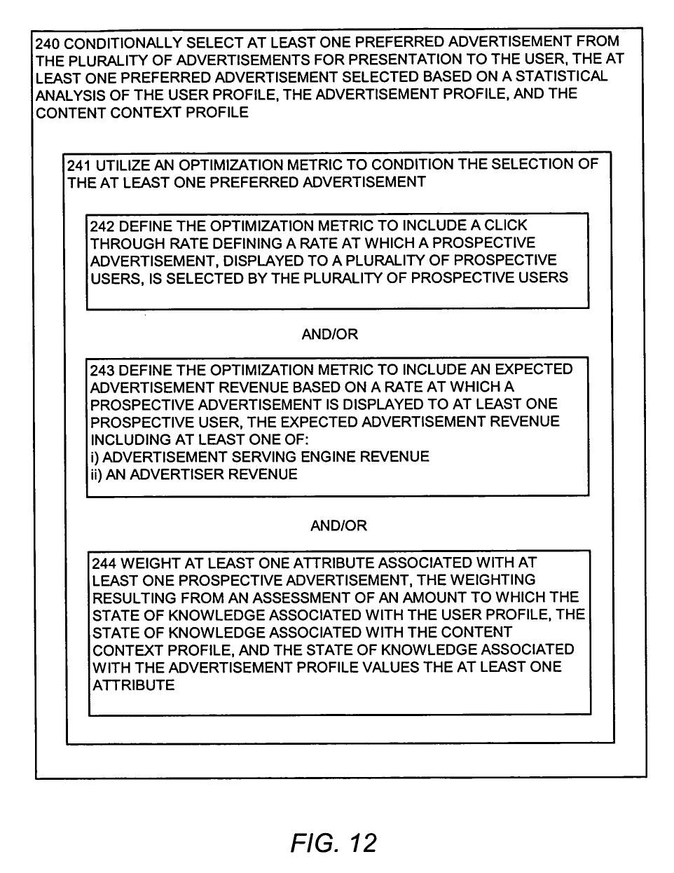

FIG. 12 is an embodiment of the steps performed by the advertisement selecting process 140-2 when it conditionally selects at least one preferred advertisement 125-1 from the plurality of advertisements for presentation to the user 108.

In step 240, the advertisement selecting process 140-2 conditionally selects at least one preferred advertisement 125-1 from the plurality of advertisements for presentation to the user 108. The preferred advertisement 125-1 is selected based on a statistical analysis of the user profile 145, the advertisement profile 150, and the content context profile 155 conditioned on business optimization metrics. In an example embodiment, the following formula is used:

Notation:

Pr(.)=probability of event in parentheses
SL=sponsored link (stand-in for any type of advertisement, promotions, coupons, etc.)
KW=key word used to fetch sponsored links from Sponsored-Link Server as necessary
SQ=vector of search queries made recently by user
U=vector of user's profile beside information on user's search queries
c(U)=user's cohort based on U, possibly latent
A=vector of relevant-to-user attributes of SL
X=vector of content context attributes, where content context is one in which links/ads are being served, etc.
Rev( )=revenue to portal or site from click (or other success outcome)

Note that X (Content context) includes attention to information on application where the advertisements/links are to be displayed (such as on a travel site versus a finance site versus a health site) as well as information on date-of-display (such as weekday, holidays or weekend) and time-of-display (such as workday hours or evening), i.e., all measurable factors besides general attributes of the user that predict variations in propensity to click. For example, the user's 108 interests and click behavior in the run-up to Valentine's Day is likely to be different from that around Super Bowl. And late-night usage entails different moods than usage during the workday.

The relevant attributes, A, of any SL can be imputed by an attributizer that analyzes the associated web page/web site URL or by explicit information provided by the creator of the link/ad. The attributizer can be an automated system or use human scorers or a combination.

Relevant information of the user is the U-vector. In practice, measurement errors are addressed for U by introducing latent cohorts and Bayesian exchangeability.

The typical set-up of the targeting system seeks to maximize expected revenue by choice of a portfolio of SLs. Consider the simpler case where we desire to find the best single SL for a user:

$${SL}^{*} = {arg max}_{SL} {Pr ( click \text{\vert} A , U , X )}^{′} Rev ( SL ) \qquad ( 3 )$$

The click probability is modeled as a logit model (or a probit model):

$$Pr ( click \text{\vert} U , A , X ) = \frac{exp ( {I}_{A , X \text{\vert} U} )}{1 + exp ( {I}_{A , X \text{\vert} U} )} \qquad ( 4 )$$

where the index I_{A,X|U}=Ab_{1U}+Xb_{2U}+AXb_{3U} has cohort-specific coefficients and allows for needed interactions between A and X.

In step 241, the advertisement selecting process 140-2 utilizes an optimization metric to condition the selection of the preferred advertisement 125-1.

Another Click Model Alternate Embodiment—the Random Coefficients Click Model:

the coefficients in the click-model are specified as:
β_{U}=ΓU+ζ_{U}

where the systematic heterogeneity in preference is induced through ΓU, while ζ_{U} captures the user-specific component. Consequently, the random coefficients click model is obtained as:

$$Pr ( click \text{\vert} U , A , X ) = Ò \frac{exp ( {I}_{A , X \text{\vert} U} )}{1 + exp ( {I}_{A , X \text{\vert} U} )} h ( {V}_{U} ) {dV}_{U}$$

where h(V_{U}) is the probability density function of V_{U}. The parameters of the click-model system are estimated using maximum likelihood or Bayesian MCMC methods, by making distributional assumptions on the random coefficients such as Multivariate Normal, etc. For simplicity and for illustrative purposes, a linear-in-parameters specification is indicated in equation for coefficients in the click-model. Non-linear model specifications can also be used for the random coefficients click model system. Updating the model coefficients towards the user 108, i.e., personalization of model coefficients is accomplished through a Bayesian model updating scheme.

In practice, cohort differences are found, such as cohorts based on gender, age, and recent visit-area information and such user-specific attributes enter into the latent cohort membership model in the latent cohort click model, or into the systematic heterogeneity component of the random coefficients click model.

The advertisement selecting process 140-2 lends itself to straightforwardly integrate out terms to accommodate users 108 for whom U is only known incompletely. Thus,
Pr(click|A,U₁,X)=ÒPr(click|A,U,X)g(U|U₁)dU

where U₁ is an incomplete profile.

In step 242, the advertisement selecting process 140-2 defines the optimization metric to include a click through rate defining a rate at which a prospective advertisement, displayed to a plurality of prospective users 108, is selected by the plurality of prospective users 108.

Alternatively, in step 243, the advertisement selecting process 140-2 defines the optimization metric to include expected advertisement revenue based on a rate at which a prospective advertisement is displayed to at least one prospective user 108. The expected advertisement revenue includes at least one of:

i) advertisement serving engine revenue, and

ii) an advertiser revenue.
Consider the simpler case (illustrated above) where we desire to find the best single SL for a user:

$${SL}^{*} = {arg max}_{SL} {Pr ( click \text{\vert} A , U , X )}^{′} Rev ( SL ) \qquad ( 5 )$$

Rev(SL) can either be revenue for the advertisement serving site or for revenue for the advertiser.

Alternatively, in step 244, the advertisement selecting process 140-2 weights at least one attribute associated with at least one prospective advertisement. The weighting resulting from an assessment of an amount to which the state of knowledge associated with the user profile 145, the state of knowledge associated with the content context profile 155, and the state of knowledge associated with the advertisement profile 150 values attribute.

Click Prediction

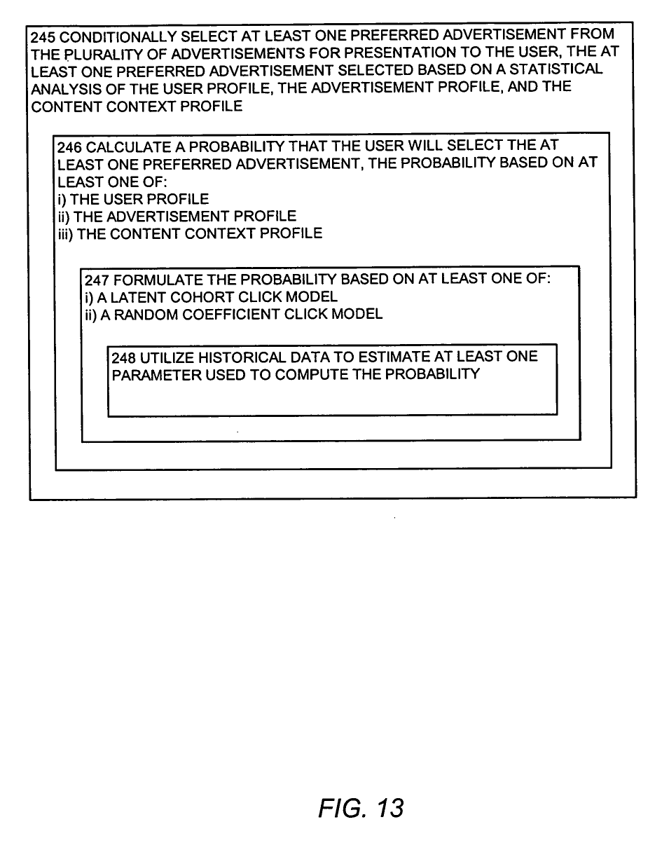

FIG. 13 is an embodiment of the steps performed by the advertisement selecting process 140-2 when it conditionally selects at least one preferred advertisement 125-1 from the plurality of advertisements for presentation to the user 108.

In step 245, the advertisement selecting process 140-2 conditionally selects at least one preferred advertisement 125-1 from the plurality of advertisements for presentation to the user 108. The preferred advertisement 125-1 is selected based on a statistical analysis of the user profile 145, the advertisement profile 150, and the content context profile 155.

In step 246, the advertisement selecting process 140-2 calculates a probability that the user 108 will select the preferred advertisement 125-1. The probability is based on at least one of:

i) the user profile 145,

ii) the advertisement profile 150, and

iii) the content context profile 155.

In step 247, the advertisement selecting process 140-2 formulates the click prediction probability based on at least one of:

i) a latent cohort click model, and

ii) a random coefficient click model.

In step 248, the advertisement selecting process 140-2 utilizes historical data from the state of knowledge of all the profiles to estimate at least one parameter used to compute the probability that the user 108 will select the preferred advertisement 125-1.

Identification and Analysis of Click vs. Non-Click

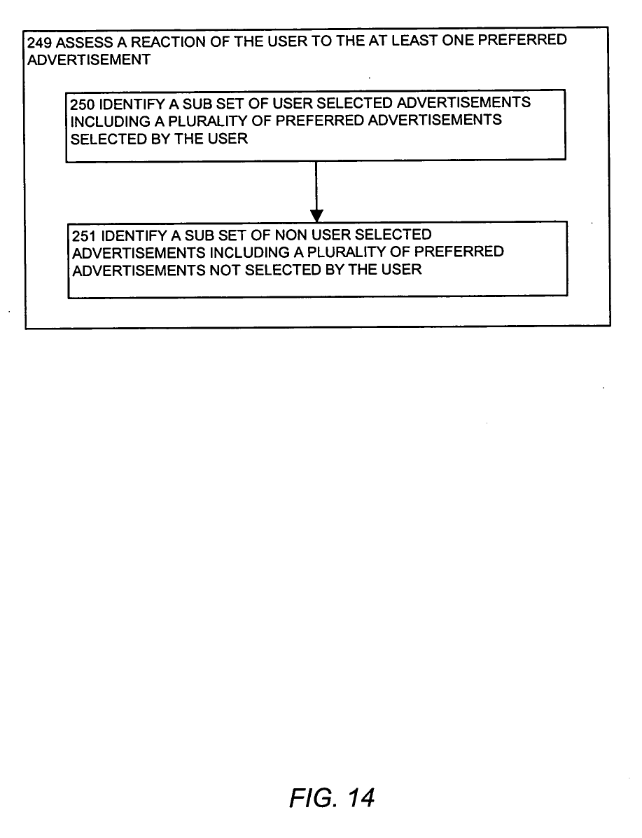

FIG. 14 is an embodiment of the steps performed by the advertisement selecting process 140-2 when it assesses a reaction of the user 108 to the preferred advertisement 125-1.

In step 249, the advertisement selecting process 140-2 assesses a reaction of the user 108 to the preferred advertisement 125-1. The preferred advertisement 125-1 is selected from the plurality of advertisements based on a statistical analysis of the user profile 145, the advertisement profile 150 and the content context profile 155.

In step 250, the advertisement selecting process 140-2 identifies a sub set of user-selected advertisements including a plurality of advertisements selected by the user 108. In an example configuration, a plurality of preferred advertisements 125-N is displayed to the user 108 and the user 108 selects a sub set of those preferred advertisements 125-N.

In step 251, the advertisement selecting process 140-2 identifies a sub set of non-user selected advertisements (i.e., “clicked”) including a plurality of advertisements not selected by the user 108. In an example configuration, a plurality of preferred advertisements 125-N is displayed to the user 108 and those preferred advertisements 125-N not selected by the user 108 are identified by the advertisement selecting process 140-2.

Upon Reaction from User

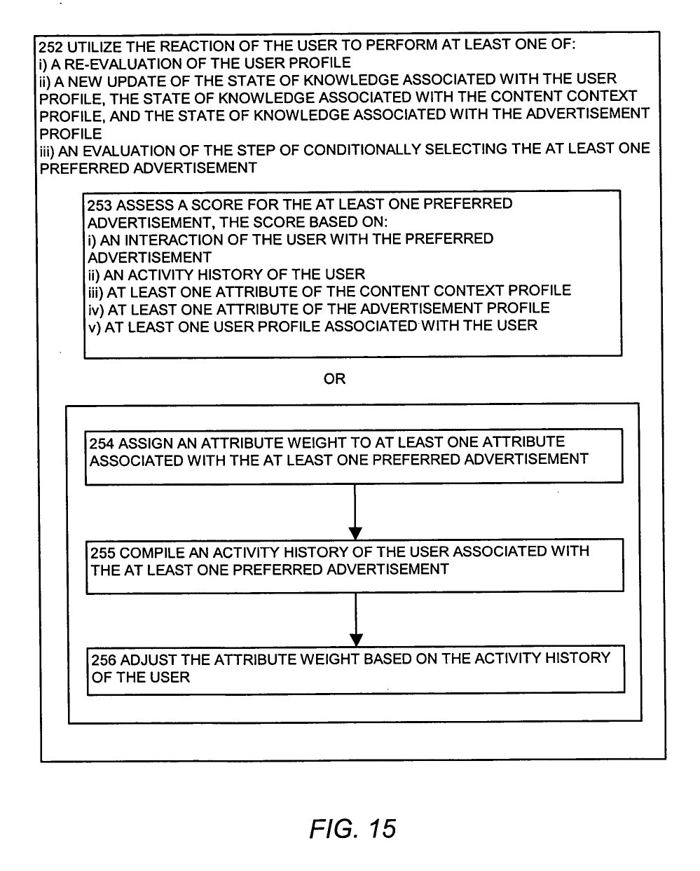

FIG. 15 is an embodiment of the steps performed by the advertisement selecting process 140-2 when it utilizes the reaction of the user 108 to re-evaluate and update the user profile 145, the advertisement profile 150, and the content context profile 155.

In step 252, the advertisement selecting process 140-2 utilizes the reaction of the user 108 to perform at least one of:

i) a re-evaluation of the user profile 145,

ii) a new update of the state of knowledge associated with the user profile 145, the state of knowledge associated with the content context profile 150, and the state of knowledge associated with the advertisement profile 155, and

iii) an evaluation of the step of conditionally selecting the preferred advertisement 125-1.

In step 253, the advertisement selecting process 140-2 assesses a score for the preferred advertisement 125-1, the score based on:

i) an interaction of the user 108 with the preferred advertisement 125-1,

ii) an activity history of the user 108,

iii) at least one attribute of the content context profile 150,

iv) at least one attribute of the advertisement profile 155, and

v) at least one user profile 145 associated with the user 108.

Alternatively, in step 254, the advertisement selecting process 140-2 assigns an attribute weight to at least one attribute associated with the preferred advertisement 125-1.

In step 255, the advertisement selecting process 140-2 compiles an activity history of the user 108 associated with the preferred advertisement 125-1. The activity history can include whether the user selected the advertisement, visited a landing page, made a purchase from the landing page, etc.

In step 256, the advertisement selecting process 140-2 adjusts the attribute weight based on the activity history of the user 108. For example, the user 108 visits a web page three times. The advertisement selecting process 140-2 adjusts the attribute weight based on this activity associated with the user 108.

Updating of State of Knowledge of all Profiles

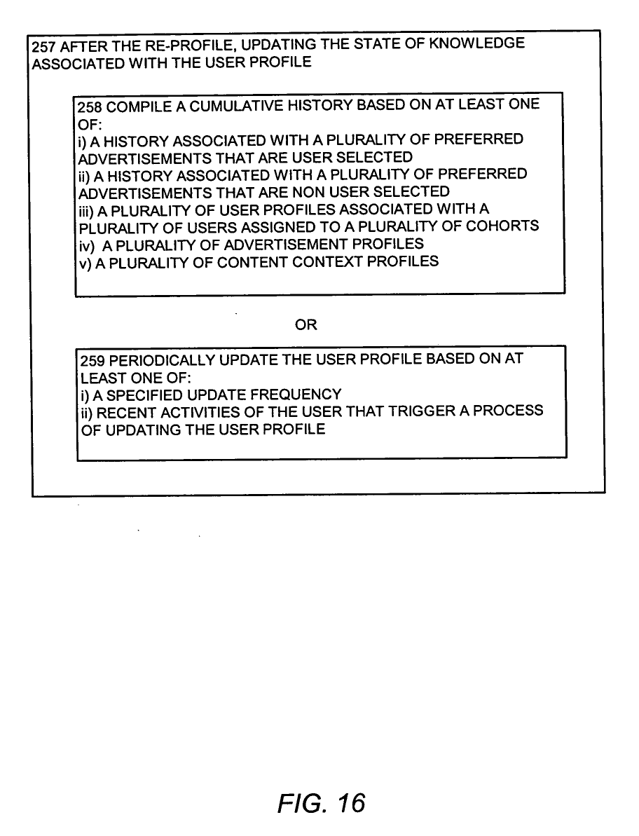

FIG. 16 is an embodiment of the steps performed by the advertisement selecting process 140-2 when it updates the state of knowledge associated with the user profile 145.

In step 257, after the re-profiling, the advertisement selecting process 140-2 updates the state of knowledge associated with the user profile 145.

In step 258, the advertisement selecting process 140-2 compiles a cumulative history based on at least one of:

i) a history associated with a plurality of advertisements that are user 108 selected,

ii) a history associated with a plurality of advertisements that are non user 108 selected,

iii) a plurality of user profiles 145 associated with a plurality of users 108 assigned to a plurality of cohorts,

iv) a plurality of advertisement profiles 150, and

v) a plurality of content context profiles 155.

Alternatively, step 259, the advertisement selecting process 140-2 periodically updates the user profile 145 based on at least one of:

i) a specified update frequency, for example process executed nightly, and

ii) recent activities of the user 108 that trigger a process of updating the user profile 145. For example, a user 108 making a purchase based on selecting a preferred advertisement 125-1 can trigger the process of updating the user profile 145.

Query Modification for Indirect Fetching of Sponsored Ads.

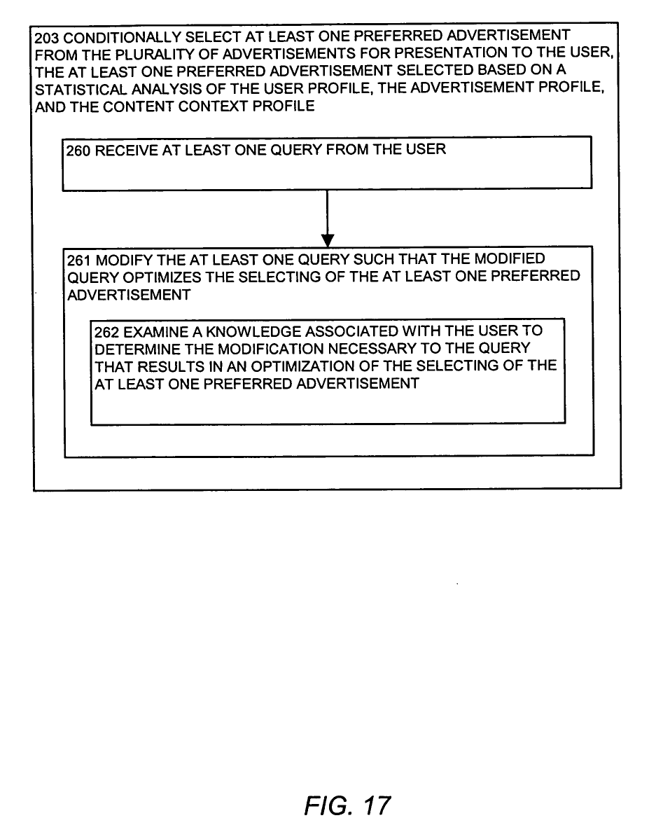

FIG. 17 is an embodiment of a continuation of the steps performed by the advertisement selecting process 140-2 when it conditionally selects at least one preferred advertisement 125-1 from the plurality of advertisements for presentation to the user 108.

In step 260, the advertisement selecting process 140-2 receives at least one query from the user 108. In an example embodiment, the user 108 enters a keyword phrase into a search engine.

In step 261, the advertisement selecting process 140-2 modifies the query such that the modified query optimizes the selecting of the preferred advertisement 125-1. In an example embodiment, the user 108 enters a keyword phrase, for example, “Cape Cod” into a search engine. The advertisement selecting process 140-2 modifies the keyword phrase to “Cape Cod vacations Martha's Vineyard” to optimize the selection of preferred advertisements 125-N for displaying to the user 108.

In step 262, the advertisement selecting process 140-2 examines a knowledge associated with the user 108 to determine the modification necessary to the query that results in an optimization of the selecting of the preferred advertisement 125-1. In an example embodiment, prior to modifying the keyword phrase, the advertisement selecting process 140-2 examines a knowledge associated with the user 108, for example, the user's 108 previous web activity, to determine the modification necessary to produce optimized results for the user 108.

In step 264, the advertisement selecting process 140-2 selects at least one subset of advertisements from the plurality of advertisements, the at least one subset of advertisements grouped as a portfolio selected to introduce variety and diversity, the at least one subset of advertisements grouped as a portfolio comprising at least one advertisements from a plurality of advertisements from a plurality of different groups that are determined by statistically analyzing the state of knowledge associated with the user profile, the state of knowledge associated with the content context profile and the state of knowledge associated with the advertisement profile.

Portfolio Considerations

The targeting system induces variety in the set of presented sponsored links through the following types of mechanisms:

Clustering of attributes of keywords: Given the taxonomy that is used to attributize ads/sponsored links, we may induce variety in the sponsored links by diversifying over attributes. For example, if the top candidate keywords (KWs) for a user are “baseball cap”, “basketball”, and “50 cent”, then the advertisement selecting process 140-2 uses “baseball cap” and “50 cent” to obtain sponsored links. The the advertisement selecting process 140-2 drops “baseball” and “basketball” since these keywords belong to the “Sports” cluster from which “baseball cap” is the highest value KW.
Clustering of recent search queries: Recent search queries are tokenized and passed through a clustering algorithm to identify clusters of search queries. These clusters serve two goals:
   Induce variety in the search queries chosen to generate sponsored links by skipping over clusters. For example, if the user's history of search queries had “baseball cap,”, “baseball”, “50 cent” in the search history, then the advertisement selecting process 140-2 keeps only one from the Sports cluster.
   Identify the intensity of the user's current interest in a particular area/category and which is positively related to the likelihood of the user's click to sponsored links in the area.

In other words, the advertisement selecting process 140-2 prevents any one keyword or keyword phrase from dominating the results. While computer systems and methods have been particularly shown and described above with references to configurations thereof, it will be understood by those skilled in the art that various changes in form and details may be made therein without departing from the scope disclosed herein. Accordingly, the information disclosed herein is not intended to be limited by the example configurations provided above.

What is claimed is:

1. A method of selecting at least one advertisement, the method comprising:
examining a user profile based on a knowledge associated with a user;
examining a content context profile associated with a type of application and an application environment;
examining an advertisement profile associated with a plurality of advertisements, the plurality of advertisements including a plurality of attributes; and
conditionally selecting at least one preferred advertisement from the plurality of advertisements for presentation to the user, the at least one preferred advertisement selected based on a statistical analysis of the user profile, the advertisement profile, and the content context profile.

2. The method of claim 1 comprising:
creating the user profile;
initializing a state of knowledge associated with the user profile;
re-profiling the user profile; and
after the re-profiling, updating the state of knowledge associated with the user profile.

3. The method of claim 1 comprising:
creating the content context profile;
initializing a state of knowledge associated with the content context profile;
re-profiling the content context profile; and
after the re-profiling, updating the state of knowledge associated with the content context profile.

4. The method of claim 1 comprising:
creating the advertisement profile;
initializing a state of knowledge associated with the advertisement profile;
re-profiling the advertisement profile; and
after the re-profiling, updating the state of knowledge associated with the advertisement profile.

5. The method of claim 1 further comprising:
assessing a reaction of the user to the at least one preferred advertisement; and
utilizing the reaction of the user to perform at least one of:
i) a re-evaluation of the user profile;
ii) a new update of the state of knowledge associated with the user profile, the state of knowledge associated with the content context profile, and the state of knowledge associated with the advertisement profile; and
iii) an evaluation of the step of conditionally selecting the at least one preferred advertisement.

6. The method of claim 1 wherein examining a user profile based on a knowledge associated with a user comprises:
assigning the user to at least one cohort, the at least one cohort including at least one of:
i) a demographic cohort;
ii) a geographic cohort;
iii) a latent cohort; and
iv) an advertisement preference cohort.

7. The method of claim 6 wherein assigning the user to at least one cohort comprises:
using a probabilistic cohort selection technique to assign the user to a latent cohort.

8. The method of claim 6 wherein assigning the user to at least one cohort comprises:
assigning the user to a default cohort; and
inheriting a default profile.

9. The method of claim 6 wherein assigning the user to at least one cohort comprises:
evaluating the knowledge associated with the user including at least one of:
i) at least one demographic of the user;
ii) at least one socioeconomic characteristic of the user;
iii) at least one location of the user;
iv) at least one user rating;
v) at least one web page hyperlink selection;
vi) at least one web page viewing;
vii) at least one advertisement impression selected by the user;
viii) at least one advertisement impression not selected by the user;
ix) at least one recent search query; and
x) at least one recent interest of the user.

10. The method of claim 9 wherein evaluating the knowledge associated with the user comprises:
evaluating at least one recent search query including at least one of:
i) at least one web search query;
ii) at least one product search query;
iii) at least one entertainment search query;
iv) at least one movie search query;
v) at least one music search query;
vi) at least one television search query;
vii) at least one video search query;
viii) at least one media search query; and
ix) at least one image search query.

11. The method of claim 9 wherein evaluating the knowledge associated with the user comprises:
evaluating the at least one recent interest of the user including at least one of:
i) at least one recent searched query;
ii) at least one page recently visited;
iii) at least one advertisement recently selected;
iv) at least one product recently purchased;
v) at least one product recently shopped for; and
vi) at least one current location associated with the user.

12. The method of claim 1 wherein examining an advertisement profile associated with a plurality of advertisements comprises:
examining at least one prospective advertisement within the plurality of advertisements, the at least one prospective advertisement including at least one of:
i) a text advertisement;
ii) a banner advertisement;
iii) a rich media advertisement;
iv) a marketing promotion;
v) a coupon; and
vi) a product recommendation.

13. The method of claim 1 wherein examining a content context profile associated with a type of application and an application environment comprises:
creating a content context profile including at least one of:
i) a web page on which the at least one prospective advertisement is presented;
ii) a portable device on which the at least one prospective advertisement is presented;
iii) a customer service platform on which the at least one prospective advertisement is presented;
iv) a call center in which the at least one prospective advertisement is presented;
v) a kiosk on which the at least one prospective advertisement is presented;
vi) a media platform on which the at least one prospective advertisement is presented;
vii) a campaign associated with an event at which the at least one prospective advertisement is presented;
viii) an intended locale where the at least one prospective advertisement will be presented to the at least one user;
ix) a plurality of web pages; and
x) a plurality of web pages resulting from a search.

14. The method of claim 13 wherein creating a content context profile comprises:
examining at least one attribute associated with the content context profile, the at least one attribute including at least one of:
i) at least one attribute of a web page on which the at least one prospective advertisement is presented;
ii) at least one attribute of a portable device on which the at least one prospective advertisement is presented;
iii) at least one attribute of a customer service platform on which the at least one prospective advertisement is presented;
iv) at least one attribute of a call center in which the at least one prospective advertisement is presented;
v) at least one attribute of a kiosk on which the at least one prospective advertisement is presented;
vi) at least one attribute of a media platform on which the at least one prospective advertisement is presented;
vii) at least one attribute of a campaign associated with an event at which the at least one prospective advertisement is presented;
viii) at least one attribute of an intended locale where the at least one prospective advertisement will be presented to the at least one user;
ix) at least one attribute of a plurality of web pages; and
x) at least one attribute of a plurality of web pages resulting from a search.

15. The method of claim 1 wherein examining an advertisement profile associated with a plurality of advertisements comprises:
examining at least one attribute, the at least one attribute including at least one of:
i) metadata associated with at least one prospective advertisement within the plurality of advertisements;
ii) at least one sound associated with at least one prospective advertisement within the plurality of advertisements;
iii) at least one image associated with at least one prospective advertisement within the plurality of advertisements;
iv) at least one color associated with at least one prospective advertisement within the plurality of advertisements;
v) a size associated with at least one prospective advertisement within the plurality of advertisements;
vi) at least one latent attribute associated at least one prospective advertisement within the plurality of advertisements;
vii) at least one advertiser specified tag associated at least one prospective advertisement within the plurality of advertisements; and
viii) at least one web page attribute associated with a web page to which the advertisement directs a user.

16. The method of claim 1 wherein conditionally selecting at least one preferred advertisement from the plurality of advertisements for presentation to the user comprises:
utilizing an optimization metric to condition the selection of the at least one preferred advertisement.

17. The method of claim 16 wherein utilizing an optimization metric to condition the selection of the at least one preferred advertisement comprises:
defining the optimization metric to include a click through rate defining a rate at which a prospective advertisement, displayed to a plurality of prospective users, is selected by the plurality of prospective users.

18. The method of claim 16 wherein utilizing an optimization metric to condition the selection of the at least one preferred advertisement comprises:
defining the optimization metric to include an expected advertisement revenue based on a rate at which a prospective advertisement is displayed to at least one prospective user, the expected advertisement revenue including at least one of:
i) advertisement serving engine revenue; and
ii) an advertiser revenue.

19. The method of claim 16 wherein utilizing an optimization metric to condition the selection of the at least one preferred advertisement comprises:
weighting at least one attribute associated with at least one prospective advertisement, the weighting resulting from an assessment of an amount to which the state of knowledge associated with the user profile, the state of knowledge associated with the content context profile, and the state of knowledge associated with the advertisement profile values the at least one attribute.

20. The method of claim 1 wherein conditionally selecting at least one preferred advertisement from the plurality of advertisements for presentation to the user comprises:
calculating a probability that the user will select the at least one preferred advertisement, the probability based on at least one of:
i) the user profile;
ii) the advertisement profile; and
iii) the content context profile.

21. The method of claim 20 wherein calculating a probability that the user will select the at least one preferred advertisement comprises:
formulating the probability based on at least one of:
i) a latent cohort click model; and
ii) a random coefficient click model.

22. The method of claim 21 wherein formulating the probability based at least one of a latent cohort model and a random coefficient click model comprises:
utilizing historical data to estimate at least one parameter used to compute the probability.

23. The method of claim 5 wherein assessing a reaction of the user to the at least one preferred advertisement comprises:
identifying a sub set of user selected advertisements including a plurality of advertisements selected by the user; and
identifying a sub set of non user selected advertisements including a plurality of advertisements not selected by the user.

24. The method of claim 5 wherein utilizing the reaction of the user to perform at least one of a re-evaluation of the user profile, a new update of the state of knowledge associated with the user profile, the state of knowledge associated with the content context profile, and the state of knowledge associated with the advertisement profile, and an evaluation of the step of conditionally selecting the at least one preferred advertisement comprises:
assessing a score for the at least one preferred advertisement, the score based on:
i) an interaction of the user with the preferred advertisement;
ii) an activity history of the user;
iii) at least one attribute of the content context profile;
iv) at least one attribute of the advertisement profile; and
v) at least one user profile associated with the user.

25. The method of claim 5 wherein utilizing the reaction of the user to perform at least one of a re-evaluation of the user profile, a new update of the state of knowledge associated with the user profile, the state of knowledge associated with the content context profile, and the state of knowledge associated with the advertisement profile, and an evaluation of the step of conditionally selecting the at least one preferred advertisement comprises:
assigning an attribute weight to at least one attribute associated with the at least one preferred advertisement;
compiling an activity history of the user associated with the at least one preferred advertisement; and
adjusting the attribute weight based on the activity history of the user.

26. The method of claim 2 wherein updating the state of knowledge associated with the user profile comprises:
compiling a cumulative history based on at least one of:
i) a history associated with a plurality of advertisements that are user selected;
ii) a history associated with a plurality of advertisements that are non user selected;
iii) a plurality of user profiles associated with a plurality of users assigned to a plurality of cohorts;
iv) a plurality of advertisement profiles; and
v) a plurality of content context profiles.

27. The method of claim 2 wherein updating the state of knowledge associated with the user profile comprises:
periodically updating the user profile based on at least one of:
i) a specified update frequency; and
ii) recent activities of the user that trigger a process of updating the user profile.

28. The method of claim 1 comprising:
receiving at least one query from the user; and
modifying the at least one query such that the modified query optimizes the selecting of the at least one preferred advertisement.

29. The method of claim 28 wherein modifying the at least one query such that the modified query optimizes the selecting of the at least one advertisement comprises:
examining a knowledge associated with the user to determine the modification necessary to the query that results in an optimization of the selecting of the at least one advertisement.

30. The method of claim 1 wherein examining an advertisement profile associated with a plurality of advertisements comprises:
examining a location to which at least one advertisement from the plurality of advertisements directs a user; and
attributizing at least one characteristic of the location.

31. The method of claim 30 comprising:
recommending a modification of the at least one characteristic of the location to which the at least one advertisement directs a user such that the at least one advertisement is attractive to the user.

32. The method of claim 12 wherein examining at least one prospective advertisement within the plurality of advertisements comprises:
examining a title of the at least one prospective advertisement; and
examining a universal resource locator associated with the at least one prospective advertisement.

33. The method of claim 12 wherein examining at least one prospective advertisement within the plurality of advertisements comprises:
recommending a modification of content of the at least one prospective advertisement such that the at least one prospective advertisement is attractive to the user.

34. A computerized device comprising:
a memory;
a processor;
a communications interface;
an interconnection mechanism coupling the memory, the processor and the communications interface;
wherein the memory is encoded with a advertisement selecting application that when executed on the processor is capable of selecting advertisements on the computerized device by performing the operations of:
examining a user profile based on a knowledge associated with a user;
examining a content context profile associated with a type of application and an application environment;
examining an advertisement profile associated with a plurality of advertisements, the plurality of advertisements including a plurality of attributes; and
conditionally selecting at least one preferred advertisement from the plurality of advertisements for presentation to the user, the at least one preferred advertisement selected based on a statistical analysis of the user profile, the advertisement profile, and the content context profile.

35. A computer readable medium encoded with computer programming logic that when executed on a process in a computerized device provides advertisement selection, the medium comprising:
means for examining a user profile based on a knowledge associated with a user;
means for examining a content context profile associated with a type of application and an application environment;
means for examining an advertisement profile associated with a plurality of advertisements, the plurality of advertisements including a plurality of attributes; and
means for conditionally selecting at least one preferred advertisement from the plurality of advertisements for presentation to the user, the at least one preferred advertisement selected based on a statistical analysis of the user profile, the advertisement profile, and the content context profile.

36. The method of claim 9 wherein evaluating the knowledge associated with the user comprises:
evaluating the at least one user rating including at least one of:
i) at least one user rating of product;
ii) at least one user rating of entertainment;
iii) at least one user rating of movie;
iv) at least one user rating of music;
v) at least one user rating of television show; and
vi) at least one user rating of rich media.

37. The method of claim 1 wherein conditionally selecting at least one preferred advertisement from the plurality of advertisements for presentation to the user comprises:
selecting at least one subset of advertisements from the plurality of advertisements, the at least one subset of advertisements grouped as a portfolio selected to introduce variety and diversity, the at least one subset of advertisements grouped as a portfolio comprising at least one advertisements from a plurality of advertisements from a plurality of different groups that are determined by statistically analyzing the state of knowledge associated with the user profile, the state of knowledge associated with the content context profile and the state of knowledge associated with the advertisement profile.
